(19) United States
(12) Patent Application Publication
(10) Pub. No.: US 2025/0391997 A1
(43) Pub. Date: Dec. 25, 2025

(54) LITHIUM-ION BATTERY SEPARATORS AND PREPARATION METHODS THEREOF

(71) Applicant: SHANGHAI ENERGY NEW MATERIALS TECHNOLOGY CO., LTD., Shanghai (CN)

(72) Inventors: Shaobo YU, Shanghai (CN); Kun PENG, Shanghai (CN); Zhi ZHUANG, Shanghai (CN); Xiawei QI, Shanghai (CN); Yuhong CAI, Shanghai (CN); Kun LI, Shanghai (CN); Xiaoming GONG, Shanghai (CN); Yue CHENG, Shanghai (CN)

(21) Appl. No.: 18/879,741

(22) PCT Filed: Apr. 27, 2023
(86) PCT No.: PCT/CN2023/091228

§ 371 Date: Dec. 27, 2024

(30) Foreign Application Priority Data
Jun. 29, 2022 (CN) 202210757785.1

(51) Int. Cl. H01M 50/403; H01M 50/417; H01M 50/491; H01M 50/494

(52) U.S. Cl. CPC H01M 50/403; H01M 50/417; H01M 50/491; H01M 50/494

(57) ABSTRACT

The present disclosure relates to the technical field of lithium-ion battery separators, and provides a method for preparation of a lithium-ion battery separator. The method comprises: (1) mixing and heating a composition comprising a polyolefin resin, an antioxidant, and a pore-forming agent to a molten state mixture, extruding the mixture through a die, and then cooling it to form a casting piece; (2) performing a first machine direction stretching and a first transverse direction stretching on the casting piece sequenctially to obtain a stretched film; (3) performing a second machine direction stretching on the stretched film; (4) performing a second transverse direction stretching; (5) extracting the pore-forming agent in the separator to obtain a separator after extraction; (6) performing a third machine direction stretching on the separator after extraction; (7) performing a third transverse direction stretching; (8) performing a fourth transverse stretching and heat setting sequenctially to obtain the lithium-ion battery separator. The separator prepared by the process of the present disclosure is greatly improved in tensile strength in the machine and transverse directions, and its puncture strength can also be much higher than that of other separators of the same thickness.

### TECHNICAL FIELD

The present disclosure relates to the field of lithium-ion battery separators, and specifically relates to a lithium-ion battery separator and its preparation method.

### BACKGROUND ART

Lithium-ion batteries have been widely used in the fields of electronic devices, new energy vehicles, and wind power energy storage in recent years; lithium-ion battery separator is an important component of the lithium-ion battery; the separator plays an important role of separating the positive and the negative electrodes to prevent short circuit and allow the electrolyte solution to pass through so as to generate electric current; the main properties of the separator include porosity, air permeability, tensile strength, puncture strength, shutdown temperature, etc. The property of the separator directly affects the capacity, cycle performance, and safety of the batteries. Therefore, improving the properties of the separator is of great significance to the performance of lithium-ion batteries.

At present, the main process of the most common wet process for separator preparation is: Extruder→Die→CAST→Machine Direction (MD)→Transverse Direction Stretching 1 (TD1)→Extraction→Transverse Direction Stretching 2 (TD2)→Heat setting. This process is mature and controllable, and is a common process for preparing conventional base film; but due to the limitation of equipment footprint and the process, the stretching ratio of the separator that is made by this traditional process in the Machine Direction (hereinafter abbreviated as “MD”, which is the casting direction) and the Transverse Direction (hereinafter abbreviated as “TD”, which is perpendicular to the casting direction) is subject to certain restrictions, usually below 15 times, which limits the tensile strength and puncture strength of the separator. In recent years, safety issues have become common to lithium-ion batteries, and thus more and more attention has been paid to the studies on the safety of lithium-ion batteries. For some separators, the requirements for the tensile strength and the puncture strength become increasingly higher, and it is sometimes required to increase the puncture strength of the separators while minimizing the thickness of the separator. Therefore, it becomes more desirable to develop an ultra-thin separator that can possess the basic physical properties of the separator while maintaining ultra-high strength, which is not yet available.

### CONTENTS OF THE DISCLOSURE

In order to achieve the purposes as set forth, the technical solutions of the present disclosure are implemented as the follows:

In one perspective, the present disclosure provides a method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a second transverse direction stretching;
(5) extracting the pore-forming agent in the separator to obtain a separator after extraction;
(6) performing a third machine direction stretching on the separator after extraction;
(7) performing a third transverse direction stretching;
(8) performing a fourth transverse stretching and heat setting sequenctially to obtain the lithium-ion battery separator.

In some embodiments, for both the first machine direction stretching and the first transverse direction stretching in step (2), the stretching temperature ranges from 60° C. to 150° C., and the stretching ratio ranges from 3 to 15 times.

Further, in some embodiments, for the second machine direction stretching in step (3), the stretching temperature ranges from 60° C. to 140° C., and the stretching ratio ranges from 2 to 10 times.

Further, in some embodiments, for the second transverse direction stretching in step (4), the stretching temperature ranges from 90° C. to 140° C., and the stretching ratio ranges from 2 to 10 times.

Further, in some embodiments, for the third machine direction stretching in step (6), the stretching temperature ranges from 90° C. to 150° C., and the stretching ratio ranges from 1.5 to 6 times.

Further, in some embodiments, for the third transverse direction stretching in step (7), the stretching temperature ranges from 100° C. to 150° C., and the stretching ratio ranges from 1.5 to 6 times.

Further, in some embodiments, for the fourth transverse direction stretching in step (8), the stretching temperature ranges from 100° C. to 150° C., and the stretching ratio ranges from 1.1 to 2 times.

Further, in some embodiments, the temperature of heat setting in step (8) ranges from 110° C. to 150° C.

In another perspective, the present disclosure provides a method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a second transverse direction stretching;
(5) extracting the pore-forming agent in the separator to obtain a separator after extraction;
(6) performing a third machine direction stretching on the separator after extraction;
(7) performing a synchronous biaxial stretching (SBS);
(8) performing a fourth transverse stretching and heat setting sequenctially to obtain the lithium-ion battery separator.

In some embodiments, for both the first machine direction stretching and the first transverse direction stretching in step (2), the stretching temperature ranges from 60° C. to 150° C., and the stretching ratio ranges from 3 to 15 times.

Further, in some embodiments, for the second machine direction stretching in step (3), the stretching temperature ranges from 60° C. to 140° C., and the stretching ratio ranges from 2 to 10 times.

Further, in some embodiments, for the second transverse direction stretching in step (4), the stretching temperature ranges from 90° C. to 140° C., and the stretching ratio ranges from 2 to 10 times.

Further, in some embodiments, for the third machine direction stretching in step (6), the stretching temperature ranges from 90° C. to 150° C., and the stretching ratio ranges from 1.5 to 6 times.

Further, in some embodiments, for the synchronous biaxial stretching in step (7), the stretching temperature ranges from 100° C. to 150° C., and the stretching ratio ranges from 1.5×1.5 to 6×6 times.

Further, in some embodiments, for the fourth transverse direction stretching in step (8), the stretching temperature ranges from 100° C. to 150° C., and the stretching ratio ranges from 1.1 to 2 times.

Further, in some embodiments, the temperature of heat setting in step (8) ranges from 110° C. to 150° C.

In another perspective, the present disclosure provides a method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a synchronous biaxial stretching;
(5) extracting the pore-forming agent in the separator to obtain a separator after extraction;
(6) performing a third machine direction stretching on the separator after extraction;
(7) performing a third transverse direction stretching;
(8) performing a fourth transverse stretching and heat setting sequenctially to obtain the lithium-ion battery separator.

In some embodiments, for both the first machine direction stretching and the first transverse direction stretching in step (2), the stretching temperature ranges from 60° C. to 150° C., and the stretching ratio ranges from 3 to 15 times.

Further, in some embodiments, for the second machine direction stretching in step (3), the stretching temperature ranges from 60° C. to 140° C., and the stretching ratio ranges from 2 to 10 times.

Further, in some embodiments, for the synchronous biaxial stretching in step (4), the stretching temperature ranges from 90° C. to 140° C., and the stretching ratio ranges from 1.5×1.5 to 12×12 times.

Further, in some embodiments, for the third machine direction stretching in step (6), the stretching temperature ranges from 90° C. to 150° C., and the stretching ratio ranges from 1.5-6 times.

Further, in some embodiments, for the third transverse direction stretching in step (7), the stretching temperature ranges from 100° C. to 150° C., and the stretching ratio ranges from 1.5 to 6 times.

Further, in some embodiments, for the fourth transverse direction stretching in step (8), the stretching temperature ranges from 100° C. to 150° C., and the stretching ratio ranges from 1.1 to 2 times.

Further, in some embodiments, the temperature of heat setting in step (8) ranges from 110° C. to 150° C.

In another perspective, the present disclosure provides a method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a first synchronous biaxial stretching;
(5) extracting the pore-forming agent in the separator to obtain a separator after extraction;
(6) performing a third machine direction stretching on the separator after extraction;
(7) performing a second synchronous biaxial stretching;
(8) performing a fourth transverse stretching and heat setting sequenctially to obtain the lithium-ion battery separator.

In some embodiments, for both the first machine direction stretching and the first transverse direction stretching in step (2), the stretching temperature ranges from 60° C. to 150° C., and the stretching ratio ranges from 3 to 15 times.

Further, in some embodiments, for the second machine direction stretching in step (3), the stretching temperature ranges from 60° C. to 140° C., and the stretching ratio ranges from 2 to 10 times.

Further, in some embodiments, for the first synchronous biaxial stretching in step (4), the stretching temperature ranges from 90° C. to 140° C., and the stretching ratio ranges from 1.5×1.5 to 12×12 times.

Further, in some embodiments, for the third machine direction stretching in step (6), the stretching temperature ranges from 90° C. to 150° C., and the stretching ratio ranges from 1.5 to 6 times.

Further, in some embodiments, for the second synchronous biaxial stretching in step (7), the stretching temperature ranges from 100° C. to 150° C., and the stretching ratio ranges from 1.5×1.5 to 6×6 times.

Further, in some embodiments, for the fourth transverse direction stretching in step (8), the stretching temperature ranges from 100° C. to 150° C., and the stretching ratio ranges from 1.1 to 2 times.

Further, in some embodiments, the temperature of heat setting in step (8) range from 110° C. to 150° C.

Moreover, in some embodiments, the present disclosure also provides a lithium-ion battery separator, of which the thickness ranges from 3 μm to 8 μm, the transverse-direction tensile strength of the separator is greater than 5000 kgf/cm², the machine-direction tensile strength of the separator is greater than 5000 kgf/cm², the puncture strength per thickness of the separator is greater than 120 gf/μm, the porosity of the separator ranges from 30% to 60%, and the median pore diameter of the seprator ranges from 20 nm to 55 nm.

Further, the transverse-direction tensile strength of the lithium-ion battery separator disclosed herein ranges, for example, from 5000 kgf/cm² to 7500 kgf/cm², the machine-direction tensile strength of the separator ranges, for example, from 5000 kgf/cm² to 7500 kgf/cm², and the puncture strength per thickness of the separator ranges, for example, from 120 gf/μm to 200 gf/μm.

The separator prepared by the process of the present disclosure is greatly improved in tensile strength in the MD and the TD, and its puncture strength can also be much higher than that of other separators of the same thickness. When the separator disclosed herein is used inside a lithium-ion battery, it can provide better isolation and protection for the positive and negative electrodes of the battery especially when the battery is subjected to external impact, so as to avoid the risk of short circuit caused by separator rupture, and hence improve the safety performance of lithium-ion batteries.

### DESCRIPTION OF THE DRAWINGS

FIG. 1 is the flow chart of the wet process for separator preparation in the prior art;

FIG. 2 is a flow chart of a first wet process for separator preparation according to a first embodiment of the present disclosure;

FIG. 3 is a flow chart of a second wet process for separator preparation according to a second embodiment of the present disclosure;

FIG. 4 is a flow chart of a third wet process for separator preparation according to a third embodiment of the present disclosure;

FIG. 5 is a flow chart of a fourth wet process for separator preparation according to a fourth embodiment of the present disclosure;

Legends in the figures: S1—Extrusion; S2—Cooling and piece forming; S3—MD1; S4—TD1; S5—MD2; S6—TD2; S7—SBS1; S8—Extraction; S9—MD3; S10—TD3; S11—SBS2; S12—TD4; S13—Heat setting.

### SPECIFIC EMBODIMENTS

The specific embodiments of the present disclosure are described in detail below. It should be understood that the specific embodiments described herein are only used to illustrate and explain the present disclosure, but not to limit the present disclosure. The endpoints of ranges and any values disclosed herein are not limited to the precise ranges or values, which should be understood to contain values proximate to those ranges or values. For ranges of values, the endpoint values of each range, the endpoint values of each range and the individual point values, and the individual point values can be combined with each other to yield one or more new ranges of values, which shall be considered as specifically disclosed herein.

As shown in FIG. 1, the main flow of the wet process for separator preparation in the prior art is: S1 Extrusion→S2 Cooling and piece forming→S3 MD1→S4 TD1→S8 Extraction→S6 TD2→S13 Heat setting.

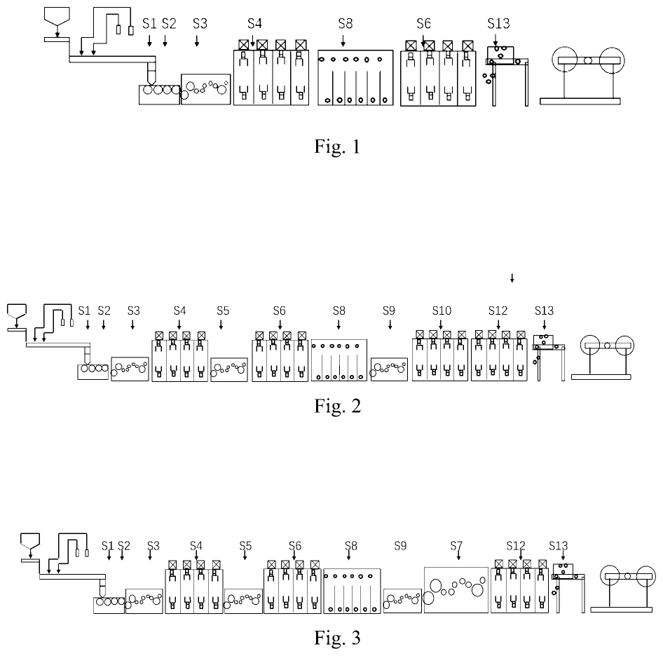

As shown in FIG. 2, the first method for preparation of a lithium-ion battery separator is provided in specific embodiments of the present disclosure, comprising:
(1) premixing dry powders of a high-molecular-weight polyethylene and an antioxidant, then adding the premixed mixture into the twin-screw extruder together with an organic pore-forming agent, extruding the mixture through a die in S1, and then cooling it through chill rolls to form a casting piece in S2;
(2) performing S3 MD1 and S4 TD1 on the casting piece sequenctially to obtain stretched film;
(3) performing S5 MD2 on the stretched film;
(4) performing S6 TD2;
(5) extracting the organic pore-forming agent in the separator by using an extractant in S8 to obtain a separator after extraction;
(6) performing S9 MD3 on the separator after extraction;
(7) performing S10 TD3;
(8) performing S12 TD4 and S13 heat-setting sequenctially to obtain the lithium-ion battery separator.

In some embodiments, the extrusion rate in the die extrusion ranges from 60 kg/h to 350 kg/h, and the extrusion temperature ranges from 150° C. to 230° C.

When the extrusion rate and/or the extrusion temperature becomes too high or too low, it may easily lead to melt fracture or excessive casting defects; the morphology of the casting piece plays an important role in maintaining high-ratio stretching, and hence if the casting piece contains many defects, it may easily lead to the rupture of the separator during the stretching.

Further, the molecular weight of the high-molecular-weight polyethylene in step (1) ranges, for example, from 600,000 to 2,000,000; the concentration of the ingredients is expressed as “in parts by mass,” for example, the amount of the high-molecular-weight polyethylene is 100 parts by mass, the amount of the antioxidant ranges, for example, from 0.1 to 1 part by mass, and the amount of the organic pore-forming agent ranges, for example, from 233 to 400 parts by mass. In some embodiments, the amount of the high-molecular-weight polyethylene is 100 parts by mass, the amount of the antioxidant ranges from 0.1 to 1 part by mass, and the amount of the organic pore-forming agent ranges from 233 to 360 parts by mass. In some embodiments, the amount of the high-molecular-weight polyethylene is 100 parts by mass, the amount of the antioxidant ranges from 0.2 to 0.5 part by mass, and the amount of the organic pore-forming agent ranges from 250 to 360 parts by mass.

Further, in some embodiments, the antioxidant in step (1) is one or more selected from amines, sulfur-containing compounds, nitrogen-containing compounds, phosphorus-containing compounds, and organic metal salts.

Further, in some embodiments, the pore-forming agent in step (1) is one or more selected from white oil, paraffin oil, and polyethylene glycol.

Further, in some embodiments, for both S3 MD1 and S4 TD1 in step (2), the stretching temperature ranges from 60° C. to 150° C., preferably from 60° C. to 125° C., such as from 60° C. to 120° C., and the stretching ratio ranges from 3 to 15 times, preferably from 8 to 15 times, such as from 8 to 10 times or from 10 to 15 times.

Further, in some embodiments, for S5 MD2 in step (3), the stretching temperature ranges from 60° C. to 140° C., preferably from 60-130° C., and the stretching ratio ranges from 2 to 10 times, preferably from 2.5 to 10 times, such as from 6.7 to 10 times, or from 7 to 10 times.

After S4 TD1 stretching, the film may become much wider, and hence the width of the film is then greatly reduced by S5 MD2 stretching, which eliminates the step of separator slitting, improves the production efficiency and equipment utilization, increases the stretching ratio of the film, and facilitates subsequent stretching.

Further, in some embodiments, for S6 TD2 in step (4), the stretching temperature ranges from 90° C. to 140° C., preferably from 90° C. to 130° C., and the stretching ratio ranges from 2 to 10 times, preferably from 2.5 to 10 times, such as from 5.7 to 10 times, or from 6 to 10 times.

S6 TD2 stretching is performed on the film with reduced width, so that the stretching ratio of the film can be further increased.

Further, in some embodiments, for S9 MD3 in step (6), the stretching temperature ranges from 90° C. to 150° C., preferably from 90° C. to 135° C., and the stretching ratio ranges from 1.5 to 6 times, preferably from 2 to 5 times, such as from 2.5 to 5 times, or from 3.3 to 5 times.

Further, in some embodiments, for S10 TD3 in step (7), the stretching temperature ranges from 100° C. to 150° C., preferably from 100° C. to 135° C., and the stretching ratio ranges from 1.5 to 6 times, preferably from 2.5 to 5 times.

Further, the stretching ratio of the S3 MD1 is set as “a”, the stretching ratio of the S4 TD1 is set as “b”, the stretching ratio of the S5 MD2 is set as “c”, the stretching ratio of the S6 TD2 is set as “d”, the stretching ratio of the S9 MD3 is set as “e”, the stretching ratio of the S10 TD3 is set as “f”, and the product of a, c, and e is defined as “m,” i.e., a×c×e=m, while the product of b, d, and f is defined as “n”, i.e., b×d×f=n. The values of both “m” and “n” range, independently, for example, from 15 to 500, preferably from 50 to 500, such as from 50 to 430, or from 50 to 428.

As disclosed herein, a S5 MD2operation together with a S6 TD2 operation are added before S8 extraction, and a S9 MD3 stretching together with a S10 TD3 stretching operation are added after S8 extraction to increase the stretching ratio in MD and TD by cascade stretching, so that the total stretching ratios “m” and “n” in MD and TD can reach a value ranging from 15 to 500 times. The separator prepared by the process of the present disclosure is thus greatly improved in tensile strength in MD and TD, and its puncture strength can also be much higher than that of other separators of the same thickness.

The method of including a S9 MD3 stretching together with a S10 TD3 stretching after S8 extraction can better control the porosity and pore diameter while improving the mechanical strength of the separator.

Further, in some embodiments, for S12 TD4 in step (8), the stretching temperature ranges from 100° C. to 150° C., preferably from 100° C. to 135° C., and the stretching ratio ranges from 1.1 to 2 times, preferably from 1.2 to 2 times.

Further, in some embodiments, the temperature of S13 heat setting in step (8) ranges from 110° C. to 150° C., preferably from 110° C. to 135° C., such as from 135° C. to 150° C.

As shown in FIG. 3, the second method for preparation of a lithium-ion battery separator is provided in specific embodiments of the present disclosure, comprising:
(1) premixing dry powders of a high-molecular-weight polyethylene and an antioxidant, then adding the premixed mixture into the twin-screw extruder together with an organic pore-forming agent, extruding the mixture through a die in S1, and then cooling it through chill rolls to form a casting piece in S2;
(2) performing S3 MD1 and S4 TD1 on the casting piece sequenctially to obtain stretched film;
(3) performing S5 MD2 on the stretched film;
(4) performing S6 TD2;
(5) extracting the organic pore-forming agent in the separator by using an extractant in S8 to obtain a separator after extraction;
(6) performing S9 MD3 on the separator after extraction;
(7) performing S7 SBS1;
(8) performing S12 TD4 and S13 heat-setting sequenctially to obtain the lithium-ion battery separator.

In some embodiments, the extrusion rate in the die extrusion ranges from 60 kg/h to 350 kg/h, and the extrusion temperature ranges from 150° C. to 230° C.

When the extrusion rate and/or the extrusion temperature is too high or too low, it may easily lead to melt fracture or excessive casting defects; the morphology of the casting piece plays an important role in maintaining high-ratio stretching, and if the casting piece contains many defects, it may easily lead to the rupture of the separator during the stretching.

Further, in some embodiments, the molecular weight of the high-molecular-weight polyethylene in step (1) ranges from 600,000 to 2,000,000; the concentration of the ingredients is expressed as “in parts by mass,” for example, the amount of the high-molecular-weight polyethylene is 100 parts by mass, and the amount of the antioxidant ranges from 0.1 to 1 part by mass, and the amount of the organic pore-forming agent ranges, for example, from 233 to 400 parts by mass. In some embodiments, the amount of the high-molecular-weight polyethylene is 100 parts by mass, the amount of the antioxidant ranges from 0.1 to 1 part by mass, and the amount of the organic pore-forming agent ranges from 233 to 360 parts by mass. In some embodiments, the amount of the high-molecular-weight polyethylene is 100 parts by mass, the amount of the antioxidant ranges from 0.2 to 0.5 part, and the amount of the organic pore-forming agent ranges from 250 to 360 parts by mass.

Further, in some embodiments, the antioxidant in step (1) is one or more selected from amines, sulfur-containing compounds, nitrogen-containing compounds, phosphorus-containing compounds, and organic metal salts.

Further, in some embodiments, the pore-forming agent in step (1) is one or more selected from white oil, paraffin oil, and polyethylene glycol.

Further, in some embodiments, for both S3 MD1 and S4 TD1 in step (2), the stretching temperature ranges from 60° C. to 150° C., preferably from 60° C. to 125° C., such as from 60° C. to 120° C., and the stretching ratio ranges from 3 to 15 times, preferably from 8 to 15 times, such as from 8 to 10 times or from 10 to 15 times.

Further, in some embodiments, for S5 MD2 in step (3), the stretching temperature ranges from 60° C. to 140° C., preferably from 60° C. to 130° C., and the stretching ratio ranges from 2 to 10 times, preferably from 2.5 to 10 times, such as from 3.3 to 10 times.

After S4 TD1 stretching, the film may become much wider, and hence the width of the film is greatly reduced by S5 MD2 stretching, which eliminates the step of separator slitting, improves the production efficiency and equipment utilization, increases the stretching ratio of the film, and facilitates subsequent stretching.

Further, in some embodiments, for S6 TD2 in step (4), the stretching temperature ranges from 90° C. to 140° C., preferably from 90° C. to 130° C., and the stretching ratio ranges from 2 to 10 times, preferably from 2.5 to 10 times, such as from 6.7 to 10 times.

S6 TD2 stretching is performed on the film with reduced width, so that the stretching ratio of the film can be further increased.

Further, in some embodiments, for S9 MD3 in step (6), the stretching temperature ranges from 90° C. to 150° C., preferably from 90° C. to 135° C., and the stretching ratio ranges from 1.5 to 6 times, preferably from 2 to 5 times, such as from 2.5 to 5 times, or from 3.3 to 5 times.

Further, in some embodiments, for S7 SBS1 in step (7), the stretching temperature ranges from 100° C. to 150° C., preferably range from 100° C. to 135° C., and the stretching ratio ranges from 1.5×1.5 to 6×6 times, preferably from 2×2 to 6×6 times, such as from 2×2 to 5×5 times.

Further, the stretching ratio of the S3 MD1 is set as “a”, the stretching ratio of the S4 TD1 is set as “b”, the stretching ratio of the S5 MD2 is set as “c”, the stretching ratio of the S6 TD2 is set as is “d”, the stretching ratio of the S9 MD3 is set as “e”, the stretching ratio of the S7 SBS1 in any direction is set as “g”, and the product of “a”, “c”, “e”, and “g” is defined as “m,” i.e., a×c×e×g=m, while the product of “b”, “d”, and “g” is defined as “n”, i.e., b×d×g=n. The values of both “m” and “n” range, independently, for example, from 15 to 500, preferably from 200 to 500, such as from 400 to 500, or from 400 to 495.

As disclosed herein, a S5 MD2operation together with a S6 TD2 operation are added before S8 extraction, and a S9 MD3 stretching together with a S7 SBS1 stretching are added after S8 extraction to increase the stretching ratio in MD and TD by cascade stretching, so that the total stretching ratios m and n in MD and TD can reach a range from 15 to 500 times. The separator prepared by the process of the present disclosure is greatly improved in tensile strength in MD and TD, and its puncture strength can also be much higher than that of other separators of the same thickness.

The method of including a S9 MD3 stretching together with S7 SBS1 stretching after S8 extraction may lead to better control of the porosity and pore diameter while improving the mechanical strength of the separator.

Further, in some embodiments, for S12 TD4 in step (8), the stretching temperature ranges from 100° C. to 150° C., preferably from 100° C. to 135° C., and the stretching ratio ranges from 1.1 to 2 times, preferably from 1.2 to 2 times.

Further, in some embodiments, the temperature of S13 heat setting in step (8) ranges from 110° C. to 150° C., preferably from 110° C. to 135° C., such as from 135° C. to 150° C.

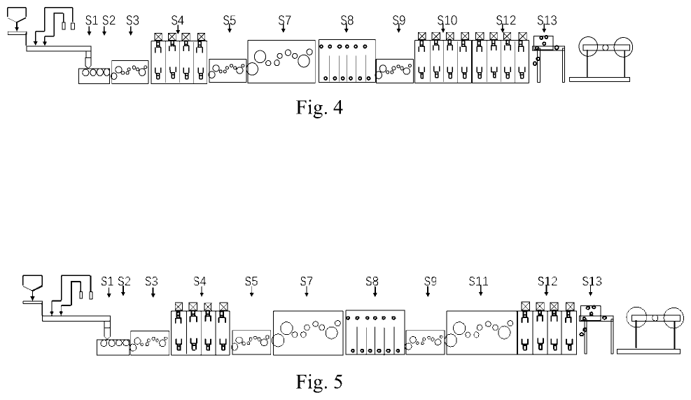

As shown in FIG. 4, the third method for preparation of a lithium-ion battery separator is provided in specific embodiments of the present disclosure, comprising:
(1) premixing dry powders of a high-molecular-weight polyethylene and an antioxidant, then adding the premixed mixture into the twin-screw extruder together with an organic pore-forming agent, extruding the mixture through a die in S1, and then cooling it through chill rolls to form a casting piece in S2;
(2) performing S3 MD1 and S4 TD1 on the casting piece sequenctially to obtain stretched film;
(3) performing S5 MD2 on the stretched film;
(4) performing S7 SBS1;
(5) extracting the organic pore-forming agent in the separator by using an extractant in S8 to obtain a separator after extraction;
(6) performing S9 MD3 on the separator after extraction;
(7) performing S10 TD3;
(8) performing S12 TD4 and S13 heat-setting sequenctially to obtain the lithium-ion battery separator.

In some embodiments, the extrusion rate in the die extrusion ranges from 60 kg/h to 350 kg/h, and the extrusion temperature ranges from 150° C. to 230° C.

When the extrusion rate and/or the extrusion temperature becomes too high or too low, it may easily lead to melt fracture or excessive casting defects; the morphology of the casting piece plays an important role in maintaining high-ratio stretching, and if the casting piece contains many defects, it may easily lead to the rupture of the separator during the stretching.

Further, in some embodiments, the molecular weight of the high-molecular-weight polyethylene in step (1) ranges from 600,000 to 2,000,000; the concentration of the ingredients is expressed as “in parts by mass,” for example, the amount of the high-molecular-weight polyethylene is 100 parts by mass, and the amount of the antioxidant ranges from 0.1 to 1 part by mass, and the amount of the organic pore-forming agent ranges, for example, from 233 to 400 parts by mass. In some embodiments, the amount of the high-molecular-weight polyethylene is 100 parts by mass, the amount of the antioxidant ranges from 0.1 to 1 part by mass, and the amount of the organic pore-forming agent ranges from 233 to 360 parts by mass. In some embodiments, the amount of the high-molecular-weight polyethylene is 100 parts by mass, the amount of the antioxidant ranges from 0.2 to 0.5 part by mass, and the amount of the organic pore-forming agent ranges from 250 to 360 parts by mass.

Further, in some embodiments, the antioxidant in step (1) is one or more selected from amines, sulfur-containing compounds, nitrogen-containing compounds, phosphorus-containing compounds, and organic metal salts.

Further, in some embodiments, the pore-forming agent in step (1) is one or more selected from white oil, paraffin oil, and polyethylene glycol.

Further, in some embodiments, for both S3 MD1 and S4 TD1 in step (2), the stretching temperature ranges from 60° C. to 150° C., preferably from 60° C. to 125° C., such as from 60° C. to 120° C., and the stretching ratio ranges from 3 to 15 times, preferably from 8 to 15 times, such as from 8 to 10 times or from 10 to 15 times.

Further, in some embodiments, for S5 MD2 in step (3), the stretching temperature ranges from 60° C. to 140° C., preferably from 60° C. to 130° C., and the stretching ratio rages from 2 to 10 times, preferably from 2.5 to 10 times.

After S4 TD1 stretching, the film may become much wider, and hence the width of the film is greatly reduced by S5 MD2 stretching, which eliminates the step of separator slitting, improves the production efficiency and equipment utilization, increases the stretching ratio of the film, and facilitates subsequent stretching.

Further, in some embodiments, for S7 SBS1 in step (4), the stretching temperature ranges from 90° C. to 140° C., preferably from 90° C. to 130° C., and the stretching ratio ranges from 1.5×1.5 to 12×12 times, preferably from 2×2 to 12×12 times, such as from 5×5 to 12×12 times or from 2×2 to 5×5 times.

S7 SBS1 stretching is performed on the film with reduced width, so that the stretching ratio of the film is further increased.

Further, in some embodiments, for S9 MD3 in step (6), the stretching temperature ranges from 90° C. to 150° C., preferably from 90° C. to 135° C., and the stretching ratio ranges from 1.5 to 6 times, preferably from 2 to 5 times, such as from 2.5 to 5 times, or from 3.3 to 5 times.

Further, in some embodiments, for S10 TD3 in step (7), the stretching temperature ranges from 100° C. to 150° C., preferably from 100° C. to 135° C., and the stretching ratio ranges from 1.5 to 6 times, preferably from 2.5 to 6 times.

Further, the stretching ratio of the S3 MD1 is set as “a”, the stretching ratio of the S4 TD1 is set as “b”, the stretching ratio of the S5 MD2 is set as “c”, the stretching ratio of the S7 SBS1 in any direction is set as “g”, the stretching ratio of the S9 MD3 is set as “e”, the stretching ratio of the S10 TD3 is set as “f”, and the product of “a”, “c”, “e”, and “g” is defined as “m,” i.e., a×c×e×g=m, while the product of “b”, “g”, and “f” is defined as “n”, i.e., b×g×f=n. The values of both “m” and “n” range, independently, for example, from 15 to 500, preferably from 40 to 500, such as from 80 to 500, from 100 to 500, from 200 to 500, or from 200 to 495.

As disclosed herein, S5 MD2 together with a S7 SBS1 operation are added before S8 extraction, and a S9 MD3 stretching together with a S10 TD3 stretching are added after S8 extraction to increase the stretching ratio in MD and TD by cascade stretching, so that the total stretching ratios “m” and “n” in MD and TD can reach a value ranging from 15 to 500 times. The separator prepared by the process of the present disclosure is greatly improved in tensile strength in MD and TD, and its puncture strength can also be much higher than that of other separators of the same thickness.

The method of including a S9 MD3 stretching together with a S10 TD3 stretching after S8 extraction lead to a better control of the porosity and pore diameter while improving the mechanical strength of the separator.

Further, in some embodiments, for S12 TD4 in step (8), the stretching temperature ranges from 100° C. to 150° C., preferably from 100° C. to 135° C., and the stretching ratio ranges from 1.1 to 2 times, preferably from 1.2 to 2 times.

Further, in some embodiments, the temperature of S13 heat setting in step (8) ranges from 110° C. to 150° C., preferably from 110° C. to 135° C., such as from 135° C. to 150° C.

As shown in FIG. 5, the fourth method for preparation of a lithium-ion battery separator is provided in specific embodiments of the present disclosure, comprising:
(1) premixing dry powders of a high-molecular-weight polyethylene and an antioxidant, then adding the premixed mixture into the twin-screw extruder together with an organic pore-forming agent, extruding the mixture through a die in S1, and then cooling it through chill rolls to form a casting piece in S2;
(2) performing S3 MD1 and S4 TD1 on the casting piece sequenctially to obtain stretched film;
(3) performing S5 MD2 on the stretched film;
(4) performing S7 SBS1;
(5) extracting the organic pore-forming agent in the separator by using an extractant in S8 to obtain a separator after extraction;
(6) performing S9 MD3 on the separator after extraction;
(7) performing S11 SBS2;
(8) performing S12 TD4 and S13 heat-setting sequenctially to obtain the lithium-ion battery separator.

In some embodiments, the extrusion rate in the die extrusion ranges from 60 kg/h to 350 kg/h, and the extrusion temperature ranges from 150° C. to 230° C.

When the extrusion rate and/or the extrusion temperature is too high or too low, it may easily lead to melt fracture or excessive casting defects; the morphology of the casting piece plays an important role in maintaining high-ratio stretching, and if the casting piece contains many defects, it may easily lead to the rupture of the separator during the stretching.

Further, in some embodiments, the molecular weight of the high-molecular-weight polyethylene in step (1) ranges from 600,000 to 2,000,000; the concentration of the ingredients is expressed as “in parts by mass,” for example, the amount of the high-molecular-weight polyethylene is 100 parts by mass, and the amount of the antioxidant ranges from 0.1 to 1 part by mass, and the amount of the organic pore-forming agent ranges, for example, from 233 to 400 parts by mass. In some embodiments, the amount of the high-molecular-weight polyethylene is 100 parts by mass, the amount of the antioxidant ranges from 0.1 to 1 part by mass, and the amount of the organic pore-forming agent ranges from 233 to 360 parts by mass. In some embodiments, the amount of the high-molecular-weight polyethylene is 100 parts by mass, the amount of the antioxidant ranges from 0.2 to 0.5 part by mass, and the amount of the organic pore-forming agent ranges from 250 to 360 parts by mass.

Further, in some embodiments, the antioxidant in step (1) is one or more selected from amines, sulfur-containing compounds, nitrogen-containing compounds, phosphorus-containing compounds, and organic metal salts.

Further, in some embodiments, the pore-forming agent in step (1) is one or more selected from white oil, paraffin oil, and polyethylene glycol.

Further, in some embodiments, for both S3 MD1 and S4 TD1 in step (2), the stretching temperature ranges from 60° C. to 150° C., preferably from 60° C. to 125° C., such as from 60° C. to 120° C., and the stretching ratio ranges from 3 to 15 times, preferably from 3.75 to 15 times, such as from 8 to 15 times, from 8 to 10 times or from 10 to 15 times.

Further, in some embodiments, for S5 MD2 in step (3), the stretching temperature ranges from 60° C. to 140° C., preferably from 60° C. to 130° C., and the stretching ratio range from 2 to 10 times, preferably from 2.5 to 10 times.

After S4 TD1 stretching, the film may become much wider, and hence the width of the film is then greatly reduced by S5 MD2 stretching, which eliminates the step of separator slitting, improves the production efficiency and equipment utilization, increases the stretching ratio of the film, and facilitates subsequent stretching.

Further, in some embodiments, for S7 SBS1 in step (4), the stretching temperature ranges from 90° C. to 140° C., preferably from 90° C. to 130° C., and the stretching ratio ranges from 1.5×1.5 to 12×12 times, preferably from 2×2 to 12×12 times, such as from 5×5 to 12×12 times or from 2×2 to 10×10 times.

Here, S7 SBS1 stretching is performed on the film with reduced width, so that the stretching ratio of the film is further increased.

Further, in some embodiments, for S9 MD3 in step (6), the stretching temperature ranges from 90° C. to 150° C., preferably from 90° C. to 135° C., and the stretching ratio ranges from 1.5 to 6 times, preferably from 2 to 5 times, such as from 2.5 to 5 times.

Further, in some embodiments, for S11 SBS2 in step (7), the stretching temperature ranges from 100° C. to 150° C., preferably from 100° C. to 135° C., and the stretching ratio ranges from 1.5×1.5 to 6×6 times, preferably from 2×2 to 6×6 times, such as from 2×2 to 3.3×3.3 times or from 2×2 to 3×3 times.

Further, the stretching ratio of the S3 MD1 is set as “a”, the stretching ratio of the S4 TD1 is set as “b”, the stretching ratio of the S5 MD2 is set as “c”, the stretching ratio of the S7 SBS1 in any direction is set as “g”, the stretching ratio of the S9 MD3 is set as “e”, the stretching ratio of the S11 SBS2 in any direction is set as “h”, and the product of “a”, “c”, “e”, “g” and “h” is defined as “m,” i.e., a×c×e×g×h=m, while the product of “b”, “g” and “h” is defined as “n,” i.e., b×g×h=n. The values of both “m” and “n” range, independently, for example, from 15 to 500, preferably from 32 to 500, such as from 128 to 500, or from 128 to 495.

As disclosed herein, a S5 MD2 together with a S7 SBS1 operation are added before S8 extraction, and a S9 MD3 stretching together with a S11 SBS2 stretching are added after S8 extraction to increase the stretching ratio in MD and TD by cascade stretching, so that the total stretching ratios “m” and “n” in MD and TD can reach a value ranging from 15 to 500 times. The separator prepared by the process of the present disclosure is greatly improved in tensile strength in MD and TD, and its puncture strength can also be much higher than that of other separators of the same thickness.

The method of including a S9 MD3 stretching together with a S11 SBS2 stretching after S8 extraction can better control the porosity and pore diameter while improving the mechanical strength of the separator.

Further, in some embodiments, for S12 TD4 in step (8), the stretching temperature ranges from 100° C. to 150° C., preferably from 100° C. to 135° C., and the stretching ratio ranges from 1.1 to 2 times, preferably from 1.2 to 2 times.

Further, in some embodiments, the temperature of S13 heat setting in step (8) ranges from 110° C. to 150° C., preferably from 110° C. to 135° C., such as from 135° C. to 150° C.

The lithium-ion battery separator obtained by any one of the methods in the above-mentioned specific embodiments of the present disclosure has a thickness ranging, for example, from 3 μm to 8 μm, preferably from 3 μm to 5 μm, such as from 4 μm to 5 μm; the transverse-direction tensile strength of the separator is greater than 5000 kgf/cm², ranging, preferably, from 5000 kgf/cm² to 7500 kgf/cm², such as from 5200 kgf/cm² to 7500 kgf/cm², from 5500 kgf/cm² to 7500 kgf/cm², from 5800 kgf/cm² to 7500 kgf/cm², from 6300 kgf/cm² to 7500 kgf/cm², from 6600 kgf/cm² to 7500 kgf/cm², from 7100 kgf/cm² to 7500 kgf/cm², or from 7200 kgf/cm² to 7500 kgf/cm²; the machine-direction tensile strength of the separator is greater than 5000 kgf/cm², ranging, preferably, from 5000 kgf/cm² to 7500 kgf/cm², such as from 5700 kgf/cm² to 7500 kgf/cm², from 6300 kgf/cm² to 7500 kgf/cm², from 6500 kgf/cm² to 7500 kgf/cm², from 6900 kgf/cm² to 7500 kgf/cm², from 7000 kgf/cm² to 7500 kgf/cm², or from 7100 kgf/cm² to 7500 kgf/cm²; the puncture strength per thickness of the separator is greater than 120 gf/μm, ranging, preferably, from 121 gf/μm to 200 gf/μm, such as from 121 gf/μm to 190 gf/μm, from 126 gf/μm to 190 gf/μm, from 128 gf/μm to 190 gf/μm, from 131 gf/μm to 190 gf/μm, from 156 gf/μm to 190 gf/μm, or from 187 gf/μm to 190 gf/μm; the porosity of the separator ranges, for example, from 30% to 60%, preferably from 40% to 60%, such as from 41% to 47%, from 42% to 47%, from 43% to 47%, from 44% to 47%, from 45% to 47%, or from 46% to 47%; the median pore diameter of the separator ranges, for example, from 20 nm to 55 nm, preferably from 30 nm to 37 nm, such as from 32 nm to 37 nm, from 33 nm to 37 nm, from 34 nm to 37 nm, from 35 nm to 37 nm, or from 36 nm to 37 nm.

In order to further understand the present disclosure, the technical solutions provided by the present disclosure are described in detail below with reference to examples.

In the following examples and comparative examples, film performance or parameter testing is conducted according to the following methods:

### 1. Thickness

The thickness was measured according to GB/T6672-2001 Standard, and tested with C1216 thickness gauge: sampling the periphery of the prepared base film, cutting out 40 mm×60 mm sample pieces, and testing them at room temperature.

### 2. Porosity

Cutting out 40 mmx 60 mm sample pieces, measuring the mass, thickness and area of the sample pieces respectively, and calculating the density (p) of the sample pieces. The average porosity of the sample pieces is obtained from areal density using the following formula:

$$Porosity ( \% ) = [ 1 - {ρ}_{area} \div ( ρ \times d ) ] \times 100$$

### 3. Median Pore Diameter

PMI's Capillary Flow Porometer (CFP-1500AE) was used, and the surface tension of the infiltrating fluid is 15.9 Dynes/cm. The median pore diameter (ϕₘₑₐₙ) is obtained from the semi-dry curve of the “dry-wet method.”

### 4. Puncture Strength

The puncture strength was measured according to ASTM D3736 Standard, and tested with KES-G5 manual compression testing machine: cutting out 40 mm×60 mm sample pieces, and testing the sample pieces at room temperature, with the test speed of 0.2 cm/s, and the stroke of 20 mm.

### 5. MD Tensile Strength

The MD tensile strength was measured according to GB/T6672-2001 Standard, and tested with SHIMANZU (AGS-X10KN) tensile machine: cutting out 15 mm×15 mm sample pieces, and testing the sample pieces at room temperature under a test speed of 50 mm/min and a test gauge length of 10 mm.

### 6. TD Tensile Strength

The TD tensile strength was measured according to GB/T6672-2001 Standard, and tested with SHIMANZU (AGS-X10KN) tensile machine: cutting out 15 mm×15 mm sample pieces, and testing them at room temperature under a test speed of 50 mm/min and a test gauge length of 10 mm.

### Example 1

100 parts of high-molecular-weight polyethylene (average molecular weight 600,000) and 0.3 part of antioxidant were blended and stirred into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was perform on the chill rolls.

S3 MD1 stretching and S4 TD1 stretching were performed sequenctially on the casting piece, wherein the stretching ratio was both 8 times, the stretching temperature of S3 MD1 was 120° C., and the stretching temperature of S4 TD1 was 125° C.

S5 MD2 stretching was performed on the stretched separator, with a stretching ratio of 2.5 times and a stretching temperature of 130° C.; and then S6 TD2 stretching was performed, with a stretching ratio of 2.5 times and a stretching temperature of 130° C.

Dichloromethane was used as the extractant to extract the white oil by stages, with the extraction time of 30 min;

S9 MD3 stretching was performed on the separator after extraction, with a stretching ratio of 2.5 times and a stretching temperature of 135° C.; and then S10 TD3 stretching was performed, with a stretching ratio of 2.5 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 1

The blending of the same raw materials and the S1 extrusion by the same steps was completed as in Example 1; after S2 piece forming, only S3 MD1 and S4 TD1 stretching were performed at the same temperature and stretching ratio; and then S8 extraction under the same conditions was performed; after S8 extraction, S6 TD2 stretching was performed at the same temperature and stretching ratio as those of S12 TD4 in Example 1; and then S13 heat setting was performed at the same temperature and time as those in Example 1 to obtain a comparative sample.

The test results of Example 1 and Comparative Example 1 are shown as follows:

| | | Comparative |
|---|---|---|
| | Example 1 | Example 1 |
| Thickness (μm) | 4.8 | 6.6 |
| Puncture strength (gf) | 585 | 414 |
| Puncture | 121.9 | 62.7 |
| strength/thickness (gf/μm) | | |
| MD tensile strength | 5750 | 3250 |
| (kgf/cm²) | | |
| TD tensile strength | 5870 | 3450 |
| (kgf/cm²) | | |
| Porosity (%) | 42 | 36.3 |
| Median pore diameter | 33.5 | 28.5 |
| (nm) | | |

### Example 2

100 parts of high-molecular-weight polyethylene (average molecular weight 600,000) and 0.3 part of antioxidant were blended and stirred into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio was both 8 times, the stretching temperature of S3 MD1 was 120° C., and the stretching temperature of S4 TD1 was 125° C.

S5 MD2 stretching was performed on the stretched separator, with a stretching ratio of 2 times and a stretching temperature of 130° C.; and then S7 SBS1 was performed, with a stretching ratio of 2×2 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 2.5 times and a stretching temperature of 135° C.; and then S10 MD3 stretching was performed, with a stretching ratio of 2.5 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 2

The blending of the same raw materials and the S1 extrusion by the same steps as in Example 2 was completed; after S2 piece forming, only S3 MD1 and S4 TD1 stretching were perform at the same temperature and stretching ratio; and then S8 extraction was performed under the same conditions; after S8 extraction, S6 TD2 stretching was perform at the same temperature and ratio as those of S12 TD4 in Example 2; and then S13 heat setting was performed at the same temperature and time as those in Example 2 to obtain a comparative sample.

The test results of Example 2 and Comparative Example 2 are shown as follows:

| | | Comparative |
|---|---|---|
| | Example 2 | Example 2 |
| Thickness (μm) | 4.3 | 6.5 |
| Puncture strength (gf) | 545 | 409 |
| Puncture | 126.7 | 62.9 |
| strength/thickness (gf/μm) | | |
| MD tensile strength | 6380 | 3370 |
| (kgf/cm²) | | |
| TD tensile strength | 5530 | 3520 |
| (kgf/cm²) | | |
| Porosity (%) | 41.3 | 35.4 |
| Median pore diameter | 32.5 | 27.8 |
| (nm) | | |

### Example 3

100 parts of high-molecular-weight polyethylene (average molecular weight 600,000) and 0.3 part of antioxidant were blended and stirred into a mixture; then the mixture was poured into the feed bin of an extruder and 300 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio was both 8 times, the stretching temperature of S3 MD1 was 120° C., and the stretching temperature of S4 TD1 was 125° C.

S5 MD2 stretching was performed on the stretched separator, with a stretching ratio of 2 times and a stretching temperature of 130° C.; and then S7 SBS1 stretching was performed, with a stretching ratio of 5×5 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 2.5 times and a stretching temperature of 135° C.; and then S10 MD3 stretching was performed, with a stretching ratio of 2.5 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 3

The blending of the same raw materials and the S1 extrusion were completed by the same steps as in Example 3; after S2 piece forming, only S3 MD1 and S4 TD1 stretching were performed at the same temperature and stretching ratio; and then S8 extraction was performed under the same conditions; after S8 extraction, S6 TD2 stretching was performed at the same temperature and stretching ratio as those of S12 TD4 in Example 3; and then S13 heat setting was performed at the same temperature and time as those in Example 3 to obtain a comparative sample.

The test results of Example 3 and Comparative Example 3 are shown as follows:

| | | Comparative |
|---|---|---|
| | Example 3 | Example 3 |
| Thickness (μm) | 3.7 | 6.7 |
| Puncture strength (gf) | 487 | 421 |
| Puncture | 131.6 | 62.8 |
| strength/thickness (gf/μm) | | |
| MD tensile strength | 6980 | 3180 |
| (kgf/cm²) | | |
| TD tensile strength | 6310 | 3320 |
| (kgf/cm²) | | |
| Porosity (%) | 40.9 | 34.4 |
| Median pore diameter | 30.8 | 26.8 |
| (nm) | | |

### Example 4

100 parts of high-molecular-weight polyethylene (average molecular weight 600,000) and 0.3 part of antioxidant were blended and stirred into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequentially on the casting piece, wherein the stretching ratio was both 8 times, the stretching temperature of S3 MD1 was 120° C., and the stretching temperature of S4 TD1 was 125° C.

S5 MD2 stretching was performed on the stretched separator, with a stretching ratio of 2 times and a stretching temperature of 130° C.; and then S7 SBS1 stretching was performed, with a stretching ratio of 2×2 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 2 times and a stretching temperature of 135° C.; and then S11 SBS2 stretching was performed, with a stretching ratio of 2×2 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 4

The blending of the same raw materials and the S1 extrusion were completed by the same steps as in Example 4; after S2 piece forming, only S3 MD1 and S4 TD1 stretching were performed at the same temperature and stretching ratio; and then S8 extraction was performed under the same conditions; after S8 extraction, S6 TD2 stretching was performed at the same temperature and stretching ratio as those of S12 TD4 in Example 4; and then S13 heat setting was performed at the same temperature and time of those in Example 4 to obtain a comparative sample.

The test results of Example 4 and Comparative Example 4 are shown as follows:

| | | Comparative |
|---|---|---|
| | Example 4 | Example 4 |
| Thickness (μm) | 4.2 | 6.5 |
| Puncture strength (gf) | 538 | 411 |
| Puncture | 128.2 | 63.2 |
| strength/thickness (gf/μm) | | |
| MD tensile strength | 6550 | 3230 |
| (kgf/cm²) | | |
| TD tensile strength | 5210 | 3460 |
| (kgf/cm²) | | |
| Porosity (%) | 43.5 | 34.1 |
| Median pore diameter | 33.8 | 26.3 |
| (nm) | | |

### Example 5

100 parts of high-molecular-weight polyethylene (average molecular weight 600,000) and 0.3 part of antioxidant were blended and stirred into a mixture; then the mixture was poured into the feed bin of an extruder and 300 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio was both 8 times, the stretching temperature of S3 MD1 was 120° C., and the stretching temperature of S4 TD1 was 125° C.

S5 MD2 stretching was performed on the stretched separator, with a stretching ratio of 2 times and a stretching temperature of 130° C.; and then S6 TD2 stretching was performed, with a stretching ratio of 2.5 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 1.5 times and a stretching temperature of 135° C.; and then S11 SBS2 stretching was performed, with a stretching ratio of 5×5 times and a stretching temperature of 135° C.

S12 TD4 stretching was performed, with a stretching ratio of 2 times and a stretching temperature of 135° C., and then S13 heat setting was performed, with a heat setting temperature of 135° C. to obtain a lithium-ion battery separator of the present disclosure.

### Comparative Example 5

The blending of the same raw materials and the S1 extrusion were completed by the same steps as in Example 5; after S2 piece forming, S3 MD1, S4 TD1, S5 MD2, and S6 TD2 stretching were performed at the same temperature and stretching ratio; and then S8 extraction was performed under the same conditions; after S8 extraction, S12 TD4 stretching was performed at the same temperature and stretching ratio as those of S12 TD4 in Example 5; and then S13 heat setting was performed at the same temperature and time as those in Example 5 to obtain a comparative sample.

Compared with Example 5, the S9 MD3 and S11 SBS2 stretching was deleted in the method in Comparative Example 5, and the other steps of the process remain the same. This comparative example was used to verify the effect of this stretching on the physical properties of the separator.

The test results of Example 5 and Comparative Example 5 are shown as follows:

| | | Comparative |
|---|---|---|
| | Example 5 | Example 5 |
| Thickness (μm) | 4.2 | 6.7 |
| Puncture strength (gf) | 545.2 | 451.6 |
| Puncture | 129.8 | 67.4 |
| strength/thickness (gf/μm) | | |
| MD tensile strength | 6510 | 3710 |
| (kgf/cm²) | | |
| TD tensile strength | 6320 | 3800 |
| (kgf/cm²) | | |
| Porosity (%) | 44.6 | 35.2 |
| Median pore diameter | 34.5 | 25.6 |
| (nm) | | |

### Example 6

100 parts of high-molecular-weight polyethylene (average molecular weight 600,000) and 0.3 part of antioxidant were blended into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio was both 15 times, the stretching temperature of S3 MD1 was 120° C., and the stretching temperature of S4 TD1 was 125° C.

S5 MD2 stretching was performed on the stretched separator, with a stretching ratio of 6.7 times and a stretching temperature of 130° C.; and then S6 TD2 stretching was performed, with a stretching ratio of 5.7 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 5 times and a stretching temperature of 135° C.; and then S10 MD3 stretching was performed, with a stretching ratio of 5 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 6

The blending of the same raw materials and the S1 extrusion were completed by the same steps as in Example 6; after S2 piece forming, only S3 MD1 and S4 TD1 stretching were performed at the same temperature and stretching ratio; and then S8 extraction was performed under the same conditions; after S8 extraction, S6 TD2 stretching was performed at the same temperature and stretching ratio as those of S12 TD4 in Example 6; and then S13 heat setting was performed at the same temperature and time as those in Example 6 to obtain a comparative sample.

The test results of Example 6 and Comparative Example 6 are shown as follows:

| | | Comparative |
|---|---|---|
| | Example 6 | Example 6 |
| Thickness (μm) | 3.9 | 6.6 |
| Puncture strength (gf) | 742 | 435 |
| Puncture | 190.3 | 65.9 |
| strength/thickness (gf/μm) | | |
| MD tensile strength | 7130 | 3770 |
| (kgf/cm²) | | |
| TD tensile strength | 7250 | 3890 |
| (kgf/cm²) | | |
| Porosity (%) | 45.6 | 37.8 |
| Median pore diameter | 35.9 | 29.6 |
| (nm) | | |

### Example 7

100 parts of high-molecular-weight polyethylene (average molecular weight 600,000) and 0.3 part of antioxidant were blended and stirred into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio was both 15 times, the stretching temperature of S3 MD1 was 120° C., and the stretching temperature of S4 TD1 was 125° C.

S5 MD2 stretching was performed on the stretched separator, with a stretching ratio of 2 times and a stretching temperature of 130° C.; and then S7 SBS1 stretching was performed, with a stretching ratio of 5×5 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 3.3 times and a stretching temperature of 135° C.; and then S10 MD3 stretching was performed, with a stretching ratio of 6.7 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 7

The blending of the same raw materials and the S1 extrusion were completed by the same steps as in Example 7; after S2 piece forming, only S3 MD1 and S4 TD1 stretching were performed at the same temperature and stretching ratio; and then S8 extraction was performed under the same conditions; after S8 extraction, S6 TD2 stretching was perform at the same temperature and stretching ratio as those of S12 TD4 in Example 7; and then S13 heat setting was performed at the same temperature and time as those in Example 7 to obtain a comparative sample.

The test results of Example 7 and Comparative Example 7 are shown as follows:

| | | Comparative |
|---|---|---|
| | Example 7 | Example 7 |
| Thickness (μm) | 4.0 | 6.6 |
| Puncture strength (gf) | 757 | 441 |
| Puncture | 189.2 | 66.8 |
| strength/thickness (gf/μm) | | |
| MD tensile strength | 7170 | 3670 |
| (kgf/cm²) | | |
| TD tensile strength | 7280 | 3880 |
| (kgf/cm²) | | |
| Porosity (%) | 45.1 | 38.4 |
| Median pore diameter | 35.1 | 29.9 |
| (nm) | | |

### Example 8

100 parts of high-molecular-weight polyethylene (average molecular weight 600,000) and 0.3 part of antioxidant were blended and stirred into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio was both 15 times, the stretching temperature of S3 MD1 was 120° C., and the stretching temperature of S4 TD1 was 125° C.

S5 MD2 stretching was performed on the stretched separator, with a stretching ratio of 3.3 times and a stretching temperature of 130° C.; and then S6 TD2 stretching was performed, with a stretching ratio of 6.7 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 2 times and a stretching temperature of 135° C.; and then S11 SBS2 stretching was performed, with a stretching ratio of 5×5 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 8

The blending of the same raw materials and the S1 extrusion were completed by the same steps as in Example 8; after S2 piece forming, only S3 MD1 and S4 TD1 stretching were performed at the same temperature and stretching ratio; and then S8 extraction was performed under the same conditions; after S8 extraction, S6 TD2 stretching was performed at the same temperature and stretching ratio as those of S12 TD4 in Example 8; and then S13 heat setting was applied at the same temperature and time as those in Example 8 to obtain a comparative sample.

The test results of Example 8 and Comparative Example 8 are shown as follows:

| | | Comparative |
|---|---|---|
| | Example 8 | Example 8 |
| Thickness (μm) | 4.0 | 6.7 |
| Puncture strength (gf) | 750 | 454 |
| Puncture | 187.5 | 67.8 |
| strength/thickness (gf/μm) | | |
| MD tensile strength | 7030 | 3650 |
| (kgf/cm²) | | |
| TD tensile strength | 7170 | 3810 |
| (kgf/cm²) | | |
| Porosity (%) | 46.8 | 37.8 |
| Median pore diameter | 36.5 | 29.4 |
| (nm) | | |

### Example 9

100 parts of high-molecular-weight polyethylene (average molecular weight 600,000) and 0.3 part of antioxidant were blended and stirred into a mixture; then the mixture was poured into the feed bin of an extruder and 330 parts of white oil were added at the same time; the screw and extrusion rate were adjusted to make the high-molecular-weight polyethylene and the white oil be fully mixed and plasticized; S1 extrusion was performed through the die; and S2 cooling and piece forming was performed on the chill rolls.

S3 MD1 stretching and S4 TD1 stretching were performed sequenctially on the casting piece, wherein the stretching ratio of S3 MD1 was 3.75 times and the stretching temperature was 120° C., and the stretching ratio of S4 TD1 was 15 times and the stretching temperature was 125° C.

S5 MD2 stretching was performed on the stretched separator, with a stretching ratio of 2 times and a stretching temperature of 130° C.; and then S7 SBS1 stretching was performed, with a stretching ratio of 10×10 times and a stretching temperature of 130° C.

Dichloromethane was used as the extractant to extract the white oil by stages in S8, with the extraction time of 30 min;

S9 MD3 stretching was performed on the separator after S8 extraction, with a stretching ratio of 2 times and a stretching temperature of 135° C.; and then S11 SBS2 stretching was performed, with a stretching ratio of 3.3×3.3 times and a stretching temperature of 135° C.

S12 TD4 stretching was performed, with a stretching ratio of 1.2 times and a stretching temperature of 135° C., and then S13 heat setting was performed, with a heat setting temperature of 135° C. to obtain a lithium-ion battery separator of the present disclosure.

### Comparative Example 9

The blending of the same raw materials and the S1 extrusion were completed by the same steps as in Example 9; after S2 piece forming, only S3 MD1 and S4 TD1 stretching were performed at the same temperature and stretching ratio; and then S8 extraction was performed under the same conditions; after S8 extraction, S6 TD2 stretching was performed at the same temperature and stretching ratio as those of S12 TD4 in Example 9; and then S13 heat setting was performed at the same temperature and time as those in Example 9 to obtain a comparative sample.

The test results of Example 9 and Comparative Example 9 are shown as follows:

| | | Comparative |
|---|---|---|
| | Example 9 | Example 9 |
| Thickness (μm) | 3.9 | 7.5 |
| Puncture strength (gf) | 739 | 441 |
| Puncture | 189.5 | 58.8 |
| strength/thickness (gf/μm) | | |
| MD tensile strength | 7010 | 2950 |
| (kgf/cm²) | | |
| TD tensile strength | 7150 | 3430 |
| (kgf/cm²) | | |
| Porosity (%) | 45.0 | 31.6 |
| Median pore diameter | 35.0 | 24.4 |
| (nm) | | |

1. A method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a second transverse direction stretching;
(5) extracting the pore-forming agent in the separator to obtain a separator after extraction;
(6) performing a third machine direction stretching on the separator after extraction;
(7) performing a third transverse direction stretching;
(8) performing a fourth transverse stretching and heat setting sequentially to obtain the lithium-ion battery separator.

2. A method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a second transverse direction stretching;
(5) extracting the pore-forming agent in the separator to obtain a separator after extraction;
(6) performing a third machine direction stretching on the separator after extraction;
(7) performing a synchronous biaxial stretching;
(8) performing a fourth transverse stretching and heat setting sequenctially to obtain the lithium-ion battery separator.

3. A method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequenctially to obtain a stretched film;
(3) performing a second machine direction stretching on the stretched film;
(4) performing a synchronous biaxial stretching;
(5) extracting the pore-forming agent in the separator to obtain a separator after extraction;
(6) performing a third machine direction stretching on the separator after extraction;
(7) performing a third transverse direction stretching;
(8) performing a fourth transverse stretching and heat setting sequenctially to obtain the lithium-ion battery separator.

4. A method for preparation of a lithium-ion battery separator, comprising:
(1) mixing and heating a composition comprising a polyolefin resin, an antioxidant, and a pore-forming agent to form a molten state mixture, extruding the mixture through a die, and then cooling it to form a casting piece;
(2) performing a first machine direction stretching and a first transverse direction stretching on the casting piece sequentially to obtain a stretched film;
(3) performing a second machine direction stretching on the stretched film;
(4) performing a first synchronous biaxial stretching;
(5) extracting the pore-forming agent in the separator to obtain a separator after extraction;
(6) performing a third machine direction stretching on the separator after extraction;
(7) performing a second synchronous biaxial stretching;
(8) performing a fourth transverse stretching and heat setting sequentially to obtain the lithium-ion battery separator.

5. The method for preparation of a lithium-ion battery separator according to claim 1, wherein for both the first machine direction stretching and the first transverse direction stretching in step (2), the stretching temperature ranges from 60° C. to 150° C., and the stretching ratio ranges from 3 to 15 times.

6. The method for preparation of a lithium-ion battery separator according to claim 1, wherein for the second machine direction stretching in step (3), the stretching temperature ranges from 60° C. to 140° C., and the stretching ratio ranges from 2 to 10 times.

7. The method for preparation of a lithium-ion battery separator according to claim 1, wherein for the second transverse direction stretching in step (4), the stretching temperature ranges from 90° C. to 140° C., and the stretching ratio ranges from 2 to 10 times.

8. The method for preparation of a lithium-ion battery separator according to claim 3, wherein for the synchronous biaxial stretching or the first synchronous biaxial stretching in step (4), the stretching temperature ranges from 90° C. to 140° C., and the stretching ratio ranges from 1.5×1.5 to 12×12 times.

9. The method for preparation of a lithium-ion battery separator according to claim 1, wherein for the third machine direction stretching in step (6), the stretching temperature ranges from 90° C. to 150° C., and the stretching ratio ranges from 1.5 to 6 times.

10. The method for preparation of a lithium-ion battery separator according to claim 1, wherein for the third transverse direction stretching in step (7), the stretching temperature ranges from 100° C. to 150° C., and the stretching ratio at each direction ranges from 1.5 to 6 times.

11. The method for preparation of a lithium-ion battery separator according to claim 2, wherein for the synchronous biaxial stretching or the second synchronous biaxial stretching in step (7), the stretching temperature ranges from 100° C. to 150° C., and the stretching ratio ranges from 1.5×1.5 to 6×6 times.

12. The method for preparation of a lithium-ion battery separator according to claim 1, wherein for the fourth transverse direction stretching in step (8), the stretching temperature ranges from 100° C. to 150° C., and the stretching ratio ranges from 1.1 to 2 times.

13. The method for preparation of a lithium-ion battery separator according to claim 1, wherein the temperature of heat setting in step (8) ranges from 110° C. to 150° C. . . .

14. A lithium-ion battery separator, wherein the thickness of the separator ranges from 3 to 8 μm, the transverse-direction tensile strength of the separator is greater than 5000 kgf/cm², the machine-direction tensile strength of the separator is greater than 5000 kgf/cm², the puncture strength per thickness of the separator is greater than 120 gf/μm, the porosity of the separator ranges from 30% to 60%, and the median pore diameter of the separator ranges from 20 nm to 55 nm.

15. The lithium-ion battery separator according to claim 14, wherein the transverse-direction tensile strength of the separator ranges from 5000 kgf/cm² to 7500 kgf/cm², the machine-direction tensile strength of the separator ranges from 5000 kgf/cm² to 7500 kgf/cm², and/or the puncture strength per thickness of the seprator ranges from 120 gf/μm to 200 gf/μm.

16. The method for preparation of a lithium-ion battery separator according to claim 2, wherein for both the first machine direction stretching and the first transverse direction stretching in step (2), the stretching temperature ranges from 60° C. to 150° C., and the stretching ratio ranges from 3 to 15 times.

17. The method for preparation of a lithium-ion battery separator according to claim 2, wherein for the second machine direction stretching in step (3), the stretching temperature ranges from 60° C. to 140° C., and the stretching ratio ranges from 2 to 10 times.

18. The method for preparation of a lithium-ion battery separator according to claim 2, wherein for the second transverse direction stretching in step (4), the stretching temperature ranges from 90° C. to 140° C., and the stretching ratio ranges from 2 to 10 times.

19. The method for preparation of a lithium-ion battery separator according to claim 2, wherein for the third machine direction stretching in step (6), the stretching temperature ranges from 90° C. to 150° C., and the stretching ratio ranges from 1.5 to 6 times.

20. The method for preparation of a lithium-ion battery separator according to claim 2, wherein for the fourth transverse direction stretching in step (8), the stretching temperature ranges from 100° C. to 150° C., and the stretching ratio ranges from 1.1 to 2 times.

21. The method for preparation of a lithium-ion battery separator according to claim 2, wherein the temperature of heat setting in step (8) ranges from 110° C. to 150° C.

22. The method for preparation of a lithium-ion battery separator according to claim 3, wherein for both the first machine direction stretching and the first transverse direction stretching in step (2), the stretching temperature ranges from 60° C. to 150° C., and the stretching ratio ranges from 3 to 15 times.

23. The method for preparation of a lithium-ion battery separator according to claim 3, wherein for the second machine direction stretching in step (3), the stretching temperature ranges from 60° C. to 140° C., and the stretching ratio ranges from 2 to 10 times.

24. The method for preparation of a lithium-ion battery separator according to claim 3, wherein for the third machine direction stretching in step (6), the stretching temperature ranges from 90° C. to 150° C., and the stretching ratio ranges from 1.5 to 6 times.

25. The method for preparation of a lithium-ion battery separator according to claim 3, wherein for the third transverse direction stretching in step (7), the stretching temperature ranges from 100° C. to 150° C., and the stretching ratio at each direction ranges from 1.5 to 6 times.

26. The method for preparation of a lithium-ion battery separator according to claim 3, wherein for the fourth transverse direction stretching in step (8), the stretching temperature ranges from 100° C. to 150° C., and the stretching ratio ranges from 1.1 to 2 times.

27. The method for preparation of a lithium-ion battery separator according to claim 3, wherein the temperature of heat setting in step (8) ranges from 110° C. to 150° C.

28. The method for preparation of a lithium-ion battery separator according to claim 4, wherein for both the first machine direction stretching and the first transverse direction stretching in step (2), the stretching temperature ranges from 60° C. to 150° C., and the stretching ratio ranges from 3 to 15 times.

29. The method for preparation of a lithium-ion battery separator according to claim 4, wherein for the second machine direction stretching in step (3), the stretching temperature ranges from 60° C. to 140° C., and the stretching ratio ranges from 2 to 10 times.

30. The method for preparation of a lithium-ion battery separator according to claim 4, wherein for the synchronous biaxial stretching or the first synchronous biaxial stretching in step (4), the stretching temperature ranges from 90° C. to 140° C., and the stretching ratio ranges from 1.5×1.5 to 12×12 times.

31. The method for preparation of a lithium-ion battery separator according to claim 4, wherein for the third machine direction stretching in step (6), the stretching temperature ranges from 90° C. to 150° C., and the stretching ratio ranges from 1.5 to 6 times.

32. The method for preparation of a lithium-ion battery separator according to claim 4, wherein for the synchronous biaxial stretching or the second synchronous biaxial stretching in step (7), the stretching temperature ranges from 100° C. to 150° C., and the stretching ratio ranges from 1.5×1.5 to 6×6 times.

33. The method for preparation of a lithium-ion battery separator according to claim 4, wherein for the fourth transverse direction stretching in step (8), the stretching temperature ranges from 100° C. to 150° C., and the stretching ratio ranges from 1.1 to 2 times.

34. The method for preparation of a lithium-ion battery separator according to claim 4, wherein the temperature of heat setting in step (8) ranges from 110° C. to 150° C.
